(19) United States
(12) Patent Application Publication
(10) Pub. No.: US 2020/0388188 A1
(43) Pub. Date: Dec. 10, 2020

(54) AUDIBLE FEEDBACK SYSTEM FOR MUSCLE TRAINING

(71) Applicant: Langbourne W. Rust, Mount Kisco, NY (US)

(72) Inventor: Langbourne W. Rust, Mount Kisco, NY (US)

(73) Assignee: Langbourne Rust Research Inc., Mount Kisco, NY (US)

(21) Appl. No.: 15/877,339

(22) Filed: Jan. 22, 2018

Related U.S. Application Data
(60) Provisional application No. 62/448,443, filed on Jan. 20, 2017.

(51) Int. Cl. G09B 19/00; G08B 3/10; G10K 15/04; G06F 3/16; G09B 5/04

(52) U.S. Cl. CPC G09B 19/003; G08B 3/10; G09B 5/04; G06F 3/165; G10K 15/04

(57) ABSTRACT

The invention provides a system for detecting motions and accelerations of a subject's body and/or limbs, and converting the detected motions and accelerations into audible feedback in real time. The system is useful in sports training, job skill training, medical rehabilitation, and the arts.

### RELATED APPLICATIONS

This application claims priority of U.S. Provisional Application No. 62/448,443 filed Jan. 20, 2017.

### REFERENCE TO COMPUTER PROGRAM LISTING

This application includes an Appendix, which contains source code contained in a 47851-byte ASCII text file entitled “SkillShaperMobileUWP”, created on Jan. 21, 2018, the contents of which are incorporated herein by reference.

### FIELD OF THE INVENTION

This invention relates to methods for improving neuromuscular coordination in a subject using feedback systems to report on the subject's biomechanical motions, more particularly by providing real-time audio feedback to the subject.

### BACKGROUND

Wearable motion sensors, such as accelerometers, gyroscopes, and magnetic sensors, and force sensors such as strain gauges and piezoelectric sensors, are known to be useful tools for human motions analysis. (R. Mayagoitia, A. Nene, P. Veltink, Accelerometer and rate gyroscope measurement of kinematics: An inexpensive alternative to optical motion analysis systems. J. Biomech. (2002) 35:537-542; D. Fong, Y-Y Chan, “The Use of Wearable Inertial Motion Sensors in Human Lower Limb Biomechanics Studies: A Systematic Review.” Sensors (2010) 10:11556-11565; A. Hansen et al., “Responsive Training Device” WO 2017/152917.)

The application of these sensors to the evaluation and improvement of athletic performance is a subject of considerable interest. (M. L'Hemette et al., “New portable device for assessing locomotor performance.” Int. J. Sports Med. (2008) 29:322-326; A. Ahmadi, D. Rowlands, D. James, “Investigating the translational and rotational motion of the swing using accelerometers for athlete skill assessment.” Proceedings of 5th IEEE Conference on Sensors, Daegu, Korea, 22-25 Oct. 2006; pp. 980-983.

The use of the output of motion sensors to provide feedback to humans, as an aid to physical therapy, skill development, or athletic training, is well-established in laboratory settings. Attempts have been made to analyze motion and provide feedback with consumer applications that employ the motion sensors in smartphones, but the feedback is usually delayed relative to the activity being analyzed. A typical example is the Fly Cast Master™ application, which compares the hand motion of the user to stored data on hand motions acquired from the casts of an expert fly fisherman. The user makes a casting motion with the phone in hand, and is then presented with processed data in the form of scores relative to the expert, along with suggestions on how to make improvements.

Numerous workers have analyzed golf swing motions with accelerometers. (R. Grober, “Measuring Tempo, Rhythm, Timing and the Torques that Generate Power in the Golf Swing.” arXiv preprint (2010), arXiv:1001.1137v1; S. Chun et al., “A Sensor-Aided Self Coaching Model for Uncocking Improvement in Golf Swing.” Multimedia Tools and Applications (2014) 72:253-279.) The use of the averaged motions of professional golfers to create an idealized target set of motions, and the detection of deviations from this ideal, has been carried out via video analysis. (D. Sugimura et al., “Detecting Flaws in Golf Swing Using Common Movements of Professional Players.” Machine Vision and Applications (2016) 27:13-22.) In these prior art systems, the feedback is delayed, and presented on a cellphone or tablet via graphical or animated imagery. See, for example, the system marketed under the SkyPro™ trademark by SkyGolf LLC, which acquires data from a Bluetooth-enabled accelerometer attached to a golf club, and employs animated imagery as the feedback medium. See U.S. Pat. No. 6,441,745 for a similar performance evaluation system, employing accelerometers in wireless communication with a computing device. Real-time visual feedback, requiring the subject to watch a screen and attempt to match outputs to target values or moving images, is of limited use in that the subject is not able to simultaneously use hand-eye coordination in performing the task (e.g., one cannot return a tennis ball without looking at it.)

Audio feedback in the form of simple beeps has been has been used in connection with a body-mounted golf swing sensor (C. Jung, “Measuring Movement of Golfers with an Accelerometer.” M.S. Thesis (2012), Royal Institute of Technology, Stockholm, Sweden, p. 41), but here too, the feedback is delayed until the subject action has been completed. U.S. Pat. No. 7,857,705 describes a real-time audio feedback system for a golfer, where rotations about multiple axes are detected by gyroscopic angular rate sensors, and the output of the sensors is amplified to generate audio signals. In this system, the signal frequencies are a simple function of the detected rotational velocities.

The prior art, in summary, discloses the acquisition of a wide range of data from motion sensors, and the display of the data in a wide variety of formats, but in most of these systems there is a substantial delay (several seconds to minutes) between the activity and the feedback. Feedback associated with detection of force, acceleration, and/or direction of impact on projectiles is close to being immediate, but is still provided after the subject's motion is complete. As a result, the actual integration of the information into the user's subsequent repetitions of the motion is difficult, and the development of effective muscle memory still requires many hours of practice. The tedious training cycle of acting, observing results, and acting again has been improved by the more focused observation of more refined results, but the prior art does not avoid the cycle itself. There remains a need for a motion detector-based training system that delivers real-time feedback, in a manner that permits the human brain to associate the feedback with in-progress neuromuscular activity, and to make instantaneous modifications to the activity in progress.

### SUMMARY OF THE INVENTION

The present invention provides a system, comprising devices and software, that together provide a user with biomechanical motion feedback in real time. The feedback is provided in the form of an audible signal. Because the human brain can processes sounds almost instantaneously, the feedback is directly associated with the movement of the muscles and limbs in real time. By repeating the motion, the user is able to “shape” or tune the sounds received in feedback. Deviations from a desired pattern of accelerations and motions can be eliminated, either by minimizing sounds associated with deviations, or by attempting to match the sounds that would be generated by the desired target motions. The former method generates sound only when the motion deviates from a pre-determined “ideal” pattern of motion, enabling the subject to focus on precisely those elements of the motion that require improvement. The latter method takes advantage of the innate human ability to detect and mimic sound, particularly the musical aspects of sound. When the desired motions are converted to a “song”, mimicking the motions so as to mimic the song becomes nearly intuitive for the user, in the same way one intuitively learns speech and music. The overall effect is to accomplish the training using some of the same neural pathways that enable one to learn to play a musical instrument.

The invention has use in amateur and professional sports training, job skill training, medical rehabilitation, and the arts (e.g. dance, and other choreographed/synchronized motion.) Other uses may be foreseen by hobbyists and practitioners in other arts.

### BRIEF DESCRIPTION OF THE FIGURES

FIG. 1 shows the components of the invention, in an embodiment suitable for improving golfing skills.

FIG. 2 illustrates the flow and transfer of information according to the invention.

FIG. 3 shows a schematic representation of various stages of motion of a fly-fishing rod during a cast.

FIG. 4 shows the accelerometer data acquired during the cast of FIG. 3, with the illustrated stages indicated.

FIG. 5 shows, in musical notation, the corresponding sound output, aligned with indications of the physical steps of the cast of FIG. 3.

### DETAILED DESCRIPTION OF THE INVENTION

The invention comprises one or more motion sensors, typically accelerometers, gyroscopic sensors, and optionally one or more pressure sensors, that are attached to a held object (e.g. a tool, tennis racquet, golf club, pool cue, oar or fly rod), to an article of clothing (e.g. a glove, shoe, elastic band, or smart watch), or to a limb or to the body of a subject. The sensor(s) are in communication with and transmit the acquired data to a computing device. In preferred embodiments, the sensor(s) are in wireless communication with the computing device, for example via the Bluetooth protocol, and in particularly preferred embodiments the computing device is a smart phone or tablet computer.

In particular embodiments, sensor(s) integrated into the computing device may be employed, and communication with the device need not be wireless. For example, the accelerometers may be integral to a smart phone, which also serves as the computing device.

An application running on the computing device processes the input from the sensor(s) and outputs an audio signal, which then drives one or more speakers or earphones which convey the output to the user. Speakers or earphones can be wired to the computing device, or can receive audio signals wirelessly, as is known in the art.

The software in the particular embodiment disclosed herein carries out the following basic operations:
1. Acquire acceleration readings from one or more acceleration sensors and, if available, a gyro sensor, to produce either raw acceleration readings (which include the effects of gravity) or linear acceleration readings (which exclude the effects of gravity.) The sensor(s) preferably put out readings reflecting accelerations in orthogonal directions (e.g. the X-axis, Y-axis and Z axis);
2. Generate continuous audio output, varying in pitch and/or volume based upon the sensor reading values; and
3. Save a file of the readings for later review and analysis.

Exemplary code, provided in the Appendix, is built with C # on the Universal Windows™ Platform for compatibility with a range of devices. Those of skill in the art will appreciate that the encoding can be adapted to run on Android™ MacOS™ or iOS™ devices. The exemplary code is written to enable the invention for a user of a fly-fishing rod and for a user of a pool cue. The code can be readily modified to accommodate other tasks; alternatively it is possible to generate task-specific program modules that “plug in” to a general-purpose application. The exemplary code provides controls over almost all relevant parameters, and thus has a more complicated interface than might be desired in a consumer product. Practitioners are enabled to create a simpler interface that enables only a desired subset of controls. The principle parameter values are contained by the oSessionSettings object (of the clsSessionSettings class) set by a SetDefaults procedure in that class, and adjustable on the Settings page (pgSettings.xaml).

Preferably, the accelerometer(s) are equipped with firmware which modifies raw accelerometer readings to filter out the acceleration due to gravity, so that the output reflects only acceleration imparted by the subject. The sensors embedded in cell phones and tablet computers typically measure and provide output values for linear accelerations along the X-, Y- and Z-axes. More specialized sensors can report angular accelerations about various axes. Pressure sensors may report the strength of the subject's grip on a tool or piece of sports equipment, and/or the force of impact of the equipment on a ball, puck, or other projectile. In most cases, where the subject is attempting to replicate a pre-recorded model motion, it is important to match the location of the sensors as closely as possible to the location of the sensors at the time the data for the pre-recorded model motion was acquired.

In various embodiments, the audio output may be intermittent or continuous. The functions relating sensor readings to audio output variables may take essentially any form, so long as the output falls largely into the audible range of human hearing. The functions may combine two or more of the sensor readings in linear or non-linear combinations prior to calculating the corresponding audio output.

The subject may be guided by the apparatus and methods of the invention toward the performance of a pre-recorded desired or ideal model motion. This model motion, or more specifically the audio feedback generated by the model motion, can be recorded from the performance of an expert or professional practitioner of the task of interest. The subject may be presented with a choice of experts having varying individual styles of performance, so that a selection can be made based on personal preference or on similarities in body type.

In some embodiments, the sensor readings may be compared to readings expected from desired or ideal model motions, and the differences converted to audio signals. It will be appreciated that silence, in this context, can be regarded as a form of audio feedback. In other embodiments, the software may take a pre-selected sound pattern, e.g. a constant tone, or a musical passage, and distort it in proportion to the deviations of the motion from the desired or ideal model motion. The user, in attempting to minimize the distortions, also more closely approaches the desired set of motions.

The audio signal variables to which the software may relate the sensor readings include, but are not limited to, volume, frequency, left-right channel assignment, and waveform (e.g. sine, sawtooth, square wave, etc.) For example, the rearward and forward motions of a fly rod, pool cue, or tennis racquet can be separately processed into audio feedback for the left ear and right ear. By way of example, force and acceleration are most intuitively associated with volume, while the direction of the motion (or deviations in direction from the model motion) along one or more axes can be processed into one or more frequency component(s) of the generated audio signal. In certain embodiments, the subject is enabled to alter these correlations in the motion-to-audio conversion functions. The software may optionally modify the spectrum, envelope, and/or harmonics (collectively, the timbre) of the audio signal. In general, variations in any characteristic of an audible sound that the human ear can distinguish are contemplated to be within the scope of the invention. Variations in pitch and volume are the most preferred, because they are the variables most readily perceived by an untrained ear.

The system may be used to monitor the movement of a work or sport implement, enabling the subject to improve his or her movement of the implement. The system is also capable of monitoring various movements of the subject's body, in order to fine-tune or optimize performance. By way of example, a given motion of a fly-fishing rod, golf club, or pool cue can be achieved with a wide range of shoulder, elbow, and wrist motions, all having the same sum when the individual vector components are combined, but there may be optimal combinations that provide superior or more consistent results, conserve energy, and/or minimize the risk of injury.

The system of the invention delivers real-time feedback, in a manner that permits the human brain to associate the feedback with in-progress neuromuscular activity. Unlike prior art motion analysis methods, the method of the invention thereby enables a subject to make instantaneous modifications to the neuromuscular activity in progress.

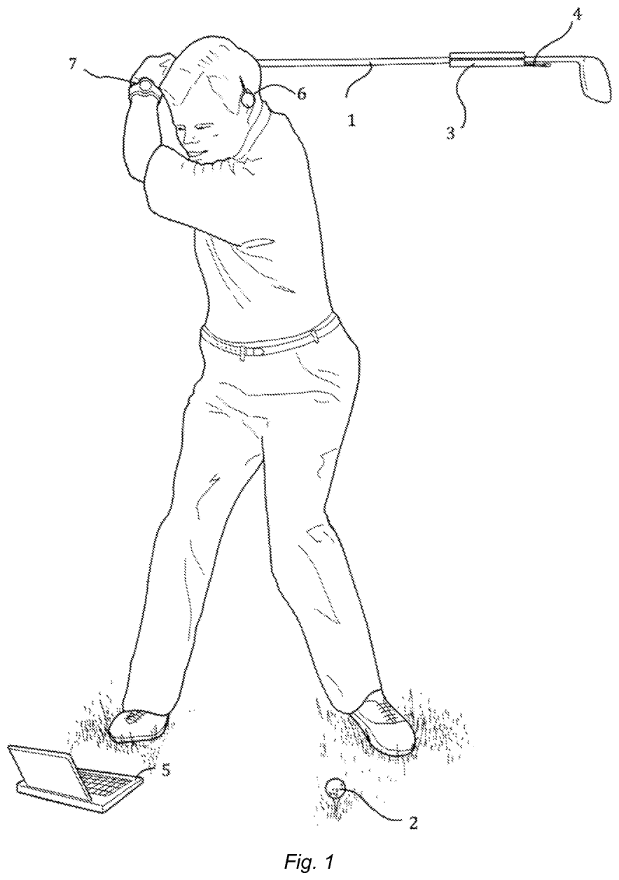

FIG. 1 illustrates the components of the system of the invention, in the particular context of a golfer using a golf club 1 to drive a golf ball 2. The club 1 is equipped with one or more motion sensors 3, which may include inertial and gyroscopic sensors. An antenna 4 sends the output of the sensors to a computing device, in this case a notebook computer 5. The device 5 converts the sensor inputs into audio signals, which are transmitted to the sound generating device, in this case a wireless (e.g. Bluetooth) earpiece 6. Optionally, motion sensors 7, also in communication with device 5, can be attached to the subject's body as well. The user thus receives real-time audio feedback that conveys the various accelerations, rotations, and translational motions of the club. Software on the device 5 can select those motions and accelerations that are most relevant to the subject, and can switch between sensors during the course of the swing as different motions and accelerations become relevant.

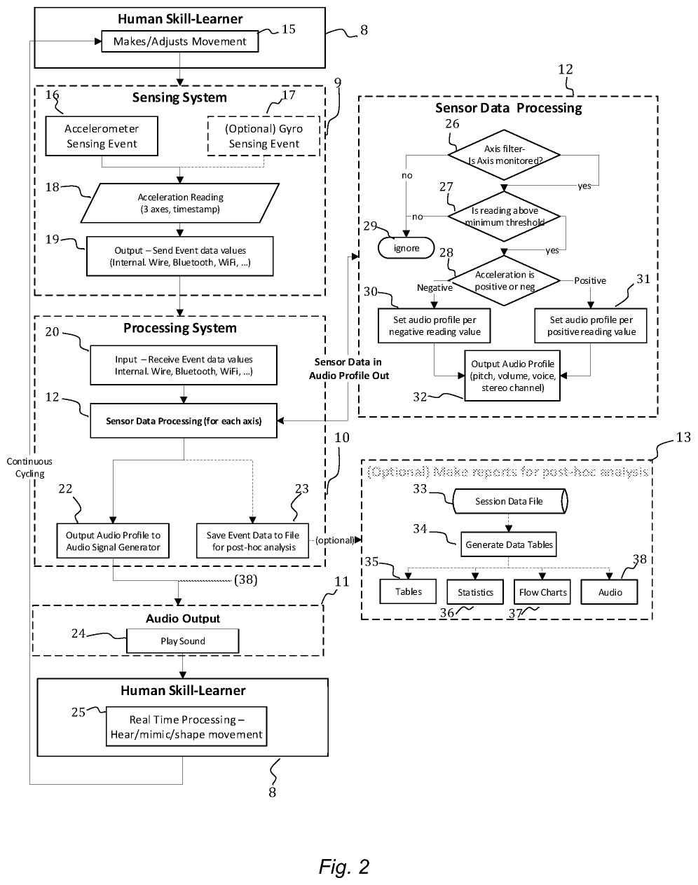

FIG. 2 is a flow chart for an embodiment of the invention, showing the generation and acquisition of motion information, the processing of motion information into audio signals, and the generation and output of the corresponding sounds. The process begins when the subject (skill-learner) 8 executes the motion to be practiced at 15. The sensing system 9 comprises at least one accelerometer 16, and optionally a gyroscopic sensor 17 and/or pressure sensor (not shown.) In the embodiment shown, accelerometers read acceleration on three orthogonal axes, and at 18 an event containing the readings and a timestamp is generated. The event data is dispatched though an output module 19, where the data is formatted and transmitted via a wired or wireless protocol. This process is repeated at a frequency consistent with the capability of the processing system 10 to generate audio signals. Typically, 10 to 200 events will be generated per second.

The processing system 10 comprises an input component 20 which receives the event data transmitted by output module 19. For each sensor, the data is processed according to pre-selected functions, or according to values stored in a look-up table, by a sensor data processing module 12 to generate audio signals that are functions of the sensor readings.

Module 12 operates by checking to see which accelerometer inputs are to be monitored for the task at hand (26). In the example provided below, for example, the axis along the direction of a fly-fishing cast is monitored exclusively. In another example, if the task at hand was the motion of a pool cue, deviations from straight-line motion would be of high importance, and motions along orthogonal axes would be monitored. The audio signals are output at 22. Inputs from non-monitored sensors are ignored (29), and inputs from monitored sensors are evaluated at 27 for threshold significance, and below-threshold signals are ignored (29) to remove noise. Thresholds, like axis selections, are task-dependent. Signals that meet the threshold test are evaluated at 28 for the sign of the acceleration. Negative acceleration (the sign is defined by the task at hand) is processed at 30 to generate an audio profile specific to negative readings, while positive acceleration is processed at 31 to generate an audio profile specific to positive acceleration. In the example provided below, positive and negative accelerations are processed into audio signals based in different octaves, with the sound frequencies being a function of acceleration. Other profiles, specific to the task at hand, may provide for channeling into left and right stereo channels, processing into different waveforms, volume being a function of acceleration, and so forth. In some embodiments, the signals may be subtracted from model signals, with the difference being output, or the model signals may be output to one stereo channel and the generated signals output to the other. The combined outputs from 30 and 31 are converted into a digital audio signal at 32, and converted at 22 to analog signals for output to the audio module 11. Optionally, the event data is also aggregated and formatted at 23 for storage and processing in report generating module 13 for later review and processing. The operations of the processing system 10 are carried out cyclically at a predetermined sampling rate. In the example provided, a 20 msec (50 Hz) sampling rate is employed, a rate that provides smooth audio output and is readily handled by current cell-phone processors.

Report generating module 13 comprises storage 33 for the session data files, data from which are assembled at 34 into data tables. From the data tables, the system can generate output tables (35), calculate statistics (36), generate flow charts (37), and produce audio files and generate audio output (38). Pre-recorded data files or data tables can be stored at 33 and used to generate audio at 38; the pre-recorded data can be generated by expert practitioners of the task at hand, and the output sounds at 24 can serve as models for the subject to attempt to match.

The analog audio signals from 22 are fed to audio output module 11, which comprises internal speakers and/or ear phones. In an alternative embodiment, digital signals from 32 are transmitted wirelessly to Bluetooth earphones or earbuds, where the functions of step 22 are carried out locally.

The sounds output at 24 are processed by the subject 8 at 25, who can then make real-time adjustments to the task being performed at 15. With a delay determined by the sampling rate, feedback arrives again at 24. The subject can also listen to model sounds, via 39 and 24, corresponding to the task as performed by an expert, and attempt to match his or her own motion-generated sounds to the model.

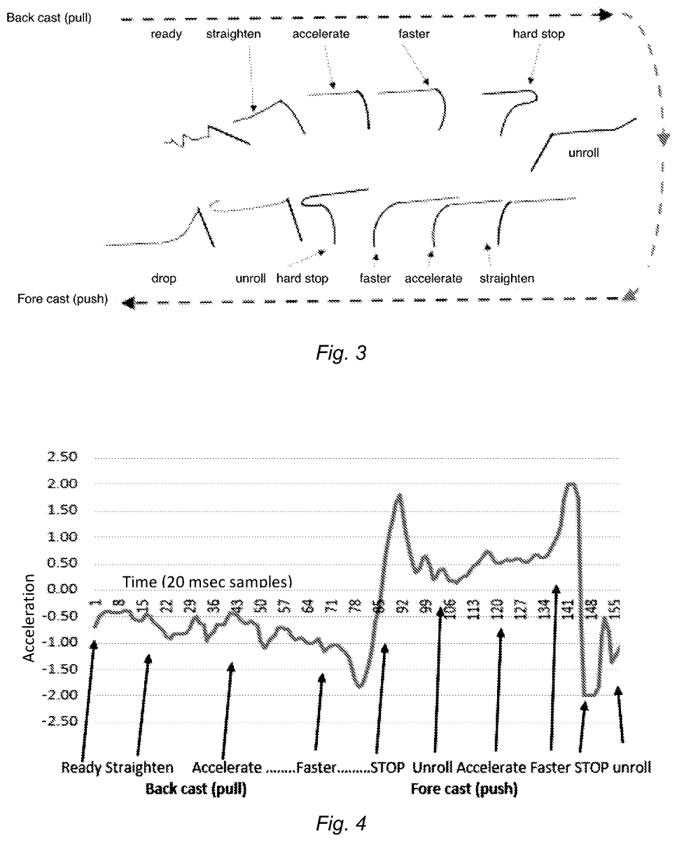

FIG. 3 shows a schematic representation of various stages of motion of a fly-fishing rod during a cast.

FIG. 4 shows the accelerometer data acquired during the cast shown in FIG. 3, with the illustrated stages indicated. An accelerometer was attached to a fly rod by mounting a cell phone firmly on the reel seat of the rod. Programming according to the invention was installed as an app and executed by the cell phone processor during the action of fly casting. Acceleration along the axis parallel to the direction of the cast was sampled at 20 msec intervals, and is plotted in units of g (gravity) force vs the sample number. An audio signal consisting of a single-frequency sine wave (middle C, MIDI 60, ca. 261 Hz) was generated, and flycasting was initiated. The middle-C tone was switched from a sine wave to a square wave upon reversal of the direction of acceleration. Throughout the cast, the frequency of the signal was shifted upward at 20 msec intervals in proportion to the absolute value of the measured acceleration. For convenience, this was accomplished via a lookup table associating g forces with frequencies, but it can also be carried out by calculation according to v=F(a), where v is the output frequency, a is the measured acceleration, and F is any desired function. The resulting audio signal was recorded, and also routed to earbuds attached to the cell phone audio jack. In this particular embodiment, it was found to be helpful to route the sine and square waves separately to the left and right audio channels. In separate experiments, the core frequency remained a sine wave, but was shifted down by one octave upon reversal of the direction of acceleration.

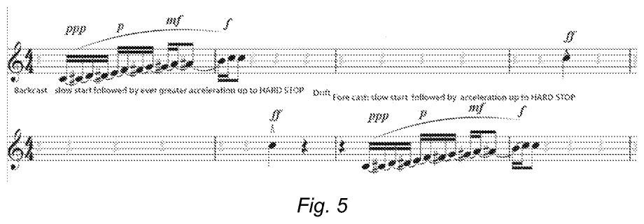

FIG. 5 is a representation in musical notation of the resulting sound output, aligned with indications of the physical steps of the cast. The sound was of excellent quality, the shifts in frequency were clearly audible, and the square and sine wave components were distinctly different to the ear. Deliberately different casts generated detectably different sounds, and it was possible with practice to make repeated casts that generated the same sound output.

The invention has been described with the aid of examples and exemplary drawings. The scope of the invention is not limited by the examples and drawings, and will be understood to encompass all variations, equivalents, and alternatives that may be obvious to those skilled in the relevant arts.

I claim:

1. A system for improving neuromuscular coordination in a subject, comprising:
(a) one or more motion sensors affixed to the subject or affixed to a tool wielded by the subject;
(b) a computing device in communication with the motion sensors; and
(c) a sound generating device controlled by the computing device;
wherein one or more translational and/or rotational accelerations are detected by the motion detectors are converted in real time by the computing device into input to the sound generating device, whereby the sound generating device produces sounds audible to the subject, and
wherein one or more sound characteristics, selected from the group consisting of volume, frequencies, waveforms and left/right channel of the sounds, are mathematically related to the translational and/or rotational accelerations detected by the motion sensors.

2. The system of claim 1, further comprising one or more pressure sensors affixed to the subject or affixed to a tool wielded by the subject;
wherein the computing device is in communication with the pressure sensors;
wherein the sound generating device converts, in real time, pressures detected by the one or more pressure sensors into input to the sound generating device; and
wherein one or more of the volume, frequencies and waveforms of the sounds are mathematically related to the pressures detected by the one or more pressure sensors.

3. The system of claim 1, wherein the motion sensors are installed within a smart phone.

4. The system of claim 2, wherein the motion sensors are installed within a smart phone.

5. The system of claim 1, wherein the computing device comprises a processor installed within a smart phone.

6. The system of claim 2, wherein the computing device comprises a processor installed within a smart phone.

7. A non-volatile computer-readable storage device, having stored therein computer-executable code, which when executed causes a computer to
(a) receive inputs from one or more motion sensors affixed to a subject or affixed to a tool wielded by the subject; and
(b) convert, in real time, the inputs from the motion sensors into audio signals that are convertible by a sound generating device into sounds audible to the subject;
wherein one or more sound characteristics, selected from the group consisting of volume, frequencies, waveforms and left/right channel of the audio signals, are mathematically related to the inputs received from the motion sensors.

8. The non-volatile computer-readable storage device of claim 7, further having stored therein computer-executable code, which when executed causes a computer to
(a) receive inputs from one or more pressure sensors affixed to a subject or affixed to a tool wielded by the subject; and
(b) convert, in real time, the inputs from the pressure sensors into audio signals that are convertible by a sound generating device into sounds audible to the subject;
wherein one or more sound characteristics, selected from the group consisting of volume, frequencies, waveforms and left/right channel of the audio signals are mathematically related to the inputs received from the pressure sensors.
